(19) United States
(12) Patent Application Publication
(10) Pub. No.: US 2024/0090032 A1
(43) Pub. Date: Mar. 14, 2024

(54) PREEMPTION WITH WIRELESS

(71) Applicant: Cisco Technology, Inc., San Jose, CA (US)

(72) Inventors: Brian D. Hart, Sunnyvale, CA (US); Matthew Aaron Silverman, Shaker Heights, OH (US); Malcolm Muir Smith, Richardson, TX (US); Jerome Henry, Pittsboro, NC (US)

(73) Assignee: Cisco Technology, Inc., San Jose, CA (US)

(21) Appl. No.: 18/465,626

(22) Filed: Sep. 12, 2023

Related U.S. Application Data
(60) Provisional application No. 63/375,317, filed on Sep. 12, 2022.

(51) Int. Cl. H04W 74/08; H04L 1/00

(52) U.S. Cl. CPC H04W 74/0816; H04L 1/0003

(57) ABSTRACT

Preemption in wireless may be provided. Access Category (AC) parameters may be received for a preemption AC within a plurality of ACs. The preemption AC parameters may comprise a Contention Window maximum (CWₘₐₓ) comprising a first predetermined value and a preemption Arbitrary Interframe Space Number (AIFSN) of less than or equal to a second predetermined value. AC parameters for others of the plurality of ACs may be received wherein a non-preemption AIFSN associated with any of the others of the plurality of ACs is greater than a sum of the first predetermined value the second predetermined value. Preemption for traffic in the preemption AC may be allowed.

### RELATED APPLICATION TECHNICAL FIELD

Under provisions of 35 U.S.C. § 119(e), Applicant claims the benefit of U.S. Provisional Application No. 63/375,317 filed Sep. 12, 2022, which is incorporated herein by reference.

### TECHNICAL FIELD

The present disclosure relates generally to preemption in wireless.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing preemption in wireless;

FIG. 2 is a flow chart of a method for providing preemption in wireless;

FIG. 3 is a flow chart of a method for providing preemption in wireless; and

FIG. 4 is a block diagram of a computing device.

### DETAILED DESCRIPTION

### Overview

Preemption in wireless may be provided. Access Category (AC) parameters may be received for a preemption AC within a plurality of ACs. The preemption AC parameters may comprise a Contention Window maximum (CWₘₐₓ) comprising a first predetermined value and a preemption Arbitrary Interframe Space Number (AIFSN) of less than or equal to a second predetermined value. AC parameters for others of the plurality of ACs may be received wherein a non-preemption AIFSN associated with any of the others of the plurality of ACs is greater than a sum of the first predetermined value the second predetermined value. Preemption for traffic in the preemption AC may be allowed.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Time Sensitive Networking (TSN) is a set of Institute of Electrical and Electronic Engineers (IEEE) 802 Ethernet sub-standards that are defined by the IEEE TSN task group. These standards enable deterministic real-time communication over Ethernet. TSN achieves determinism over Ethernet by using time synchronization and a schedule which is shared between network components. By defining queues based on time, Time-Sensitive Networking ensures a bounded maximum latency for scheduled traffic through switched networks. This means that in a TSN network, latency of critical scheduled communication may be guaranteed. The IEEE 802.1AS standard defines a mechanism to support Generic Precision Time Protocol (gPTP) (e.g., TSN based time synchronization) over Wi-Fi via the Timing Measurement (TM) or Fine Timing Measurement (FTM) protocol.

In control applications with strict deterministic requirements, such as those found in automotive and industrial domains, TSN may offer a way to send time-critical traffic over a standard Ethernet infrastructure. This may enable the convergence of all traffic classes and multiple applications in one network. In practice this may mean that the functionality of standard Ethernet may be extended so that message latency may be guaranteed through switched networks, critical and non-critical traffic may be converged in one network, and higher layer protocols can share the network infrastructure.

TSN traffic, such as packets for automated control, Augmented Reality/Virtual Reality (AR/VR), etc., may benefit from being able to be transmitted at low delay and received at the intended receiver. While queueing and scheduling schemes may improve latency, any in-progress frame/Physical Layer Protocol Data Unit (PPDU) may delay the TSN traffic even if the TSN frame is Head-of-Line (HOL) due to aggressive queuing schemes.

In the TSN space, 802.1Qbv may comprise a tool that may be used to schedule packet transmissions and thus make sure that they are forwarded as soon as they reach a given networking node. While this scheme may work well in the Ethernet space, it may become complex in the wireless space, due to the need to coordinate the traffic arrival at the Ethernet port and the 802.11 Enhanced Distributed Channel Access (EDCA) process on the radio side.

Another tool in the TSN space may comprise 802.1Qbu, which may allow a frame to request preemption, thus interrupting a frame being transmitted, to substitute to a more import/urgent frame instead. However, applying this scheme to Wi-Fi may require a complete re-definition of the 802.11 receive processing stage because APs and non-AP devices may have no responsibility to respond to 802.1Qbu frames.

Embodiments of the disclosure may use of Transmit Opportunity (TXOP) limits, Modulation and Coding Scheme (MCS) limits, Wi-Fi Multimedia (WMM)/EDCA parameters and Quality-of-Service (QoS) management to provide low-latency preemption with standard 802.11 devices. In other words, embodiments of the disclosure may provide a process to ensure an upper-bound (i.e., max) latency target for wireless (e.g., Wi-Fi applications) of 1 ms for example.

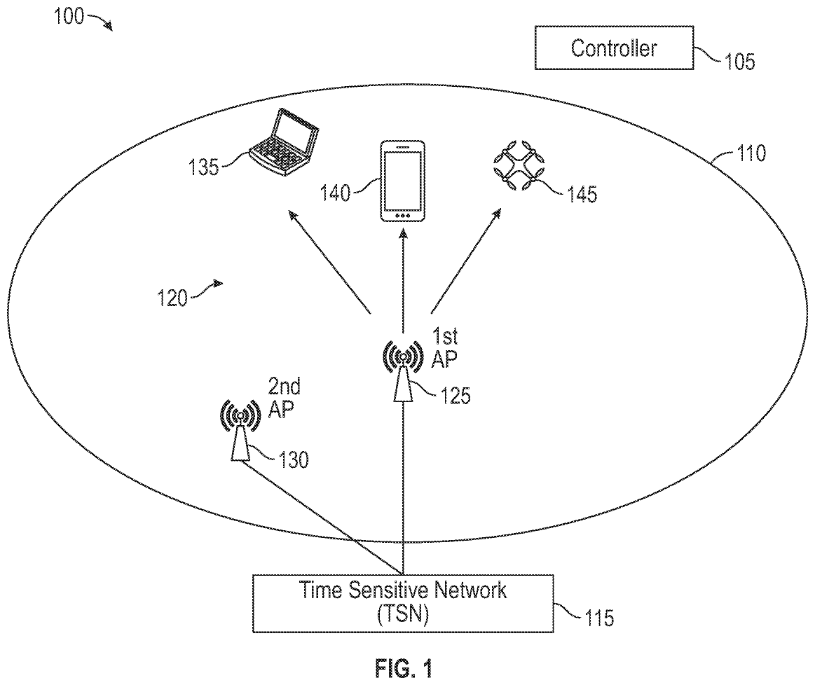

FIG. 1 shows an operating environment 100 for providing preemption in wireless. As shown in FIG. 1, operating environment 100 may comprise a controller 105, a coverage environment 110, and a Time Sensitive Network (TSN) 115. Coverage environment 110 may comprise, but is not limited to, a Wireless Local Area Network (WLAN) comprising a plurality of stations 120. The plurality of stations 120 may comprise a plurality of Access Points (APs) and a plurality of client devices. At any given time, any one of the plurality of stations 120 may comprise an Initiating Station (ISTA) or a Responding Station (RSTA). The plurality of APs may provide wireless network access (e.g., access to the WLAN) for the plurality of client devices. The plurality of APs may comprise a first AP 125 and a second AP 130. Each of the plurality of APs may be compatible with specification standards such as, but not limited to, the IEEE 802.11 specification standard for example. Coverage environment 110 may comprise, but is not limited to, an outdoor wireless environment, such as a mesh (e.g., a Wi-Fi mesh). Embodiments of the disclosure may also apply to indoor wireless environments and non-mesh environments.

Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an AR/VR device an Automated Transfer Vehicle (ATV), a drone, an Unmanned Aerial Vehicle (UAV), or other similar microcomputer-based device. In the example shown in FIG. 1, the plurality of client devices may comprise a first client device 135 (e.g., a laptop computer), a second client device 140 (e.g., a smart phone), and a third client device 145 (e.g., a drone).

Controller 105 may comprise a Wireless Local Area Network controller (WLC) and may provision and control operating environment 100 (e.g., the WLAN). Controller 105 may allow the plurality of client devices to join operating environment 100. In some embodiments of the disclosure, controller 105 may be implemented by a Digital Network Architecture Center (DNAC) controller (i.e., a Software-Defined Network (SDN) controller) that may configure information for operating environment 100 in order to provide providing preemption in wireless consistent with embodiments of the disclosure.

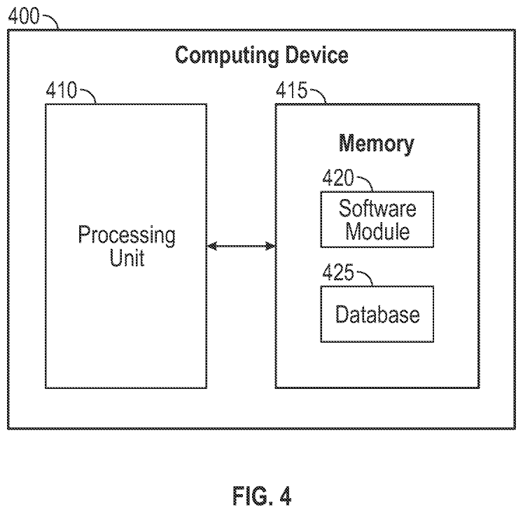

The elements described above of operating environment 100 (e.g., controller 105, first AP 125, second AP 130, first client device 135, second client device 140, and third client device 145) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

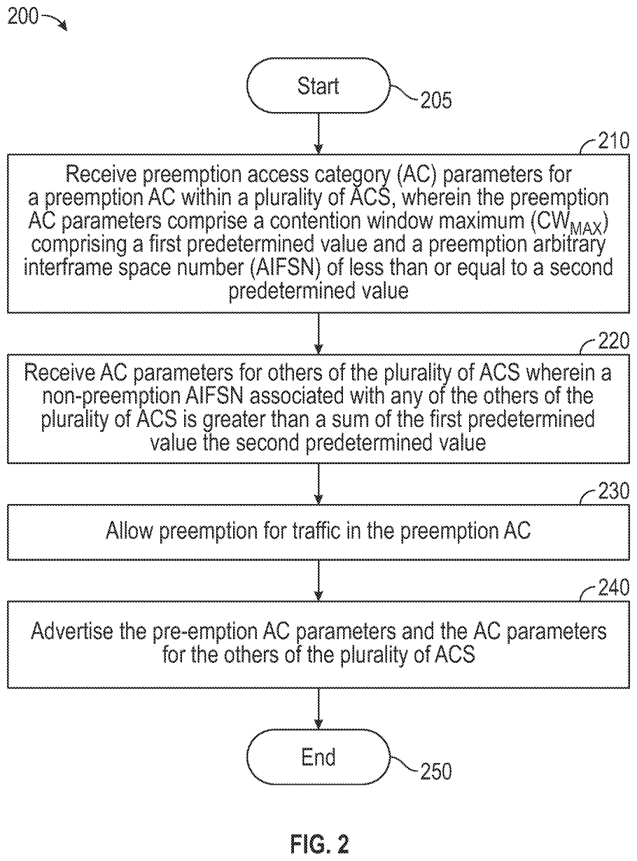

FIG. 2 is a flow chart setting forth the general stages involved in a method 200 consistent with an embodiment of the disclosure for providing preemption in wireless. Method 200 may be implemented using first AP 125 as described in more detail above with respect to FIG. 1. Ways to implement the stages of method 200 will be described in greater detail below.

Method 200 may begin at starting block 205 and proceed to stage 210 where first AP 125 may receive preemption Access Category (AC) parameters for a preemption AC within a plurality of ACs. The preemption AC parameters may comprise a Contention Window maximum (CWₘₐₓ) comprising a first predetermined value and a preemption Arbitrary Interframe Space Number (AIFSN) of less than or equal to a second predetermined value. For example, Arbitration Interframe Spacing (AIFS), in wireless LAN communications, may comprise a process of prioritizing one Access Category (AC) over the other, such as giving voice or video priority over email. One AC may be used for traffic that may be allowed to preempt all the other ACs. AIFS functions by shortening or expanding the period a wireless node has to wait before it is allowed to transmit its next frame. A shorter AIFS period may mean a message has a higher probability of being transmitted with low latency, which may be important for delay-critical data such as TSN traffic (e.g., packets for automated control, Augmented Reality/Virtual Reality (AR/VR), etc.). Contention Window refers to a window set for ACs based on the type and volume of traffic. The maximum and minimum values may be calculated to provide a wider window when needed.

From stage 210, where first AP 125 receives preemption the AC parameters for the preemption AC within the plurality of ACs, method 200 may advance to stage 220 where first AP 125 may receive AC parameters for others of the plurality of ACs. A non-preemption AIFSN associated with any of the others of the plurality of ACs is greater than a sum of the first predetermined value the second predetermined value. For example, to allow preemption by anything sent in one AC (e.g., the preemption AC), embodiments of the disclosure may configure first AP 125 to advertise WMM and/or EDCA parameters as illustrated in the following examples:
The preemption AC uses CWₘₐₓ=0 (CW=0), AIFSN=n, n<=14, and all other ACs have AIFSN>n, or
The preemption AC uses CWₘₐₓ=1 (CW=0 . . . 1), AIFSN=n, n<=13, and all other ACs have AIFSN>1+n, or
The preemption AC uses CWₘₐₓ=3 (CW=0 . . . 3), AIFSN=n, n<=11, and all other ACs have AIFSN>3+n, or
The preemption AC uses CWₘₐₓ=7 (CW=0 . . . 7), AIFSN=n, n<=7, and all other ACs have AIFSN>7+n.

Once first AP 125 receives the AC parameters for others of the plurality of ACs in stage 220, method 200 may continue to stage 230 where first AP 125 may allow preemption for traffic in the preemption AC. For example, an almost-viable configuration may be for the preemption AC to use AIFSN=2 (or 1 if allowed), CWₘₐₓ=15 and all other ACs have AIFSN=15. However, there may be a possibility that a preemption PPDU and a non-preemption PPDU could both pick 15, 16, or 17 slots, so this may not be as good a solution as the previous four example solutions.

The choice of CWₘₐₓ and n may comprise a trade-off between higher layer complexity and efficiency. If higher layers may assure that no more than one device will ever preempt during per TXOP T (or, for a safety margin, 2T or 3T), then setting CWₘₐₓ=1 and AIFSN=1 may be a good choice. However, if higher layers can reduce the average preemption rate to a low number but cannot prevent the occasional “pile-up” of contention events, then using the higher CWₘₐₓ (such as 7) may be better. CWₘᵢₙ may be set to CWₘₐₓ or smaller.

After first AP 125 allows preemption for traffic in the preemption AC in stage 230, method 200 may proceed to stage 240 where first AP 125 may advertise the preemption AC parameters and the AC parameters for the others of the plurality of ACs. For example, first AP 125 may advertise the preemption AC parameters and the AC parameters for the others of the plurality of ACs to the plurality of client devices. Third client device 145 (e.g., a drone) may be put in the preemption AC because it my have the most critical traffic. Once first AP 125 advertises the preemption AC parameters and the AC parameters for the others of the plurality of ACs in stage 240, method 200 may then end at stage 250.

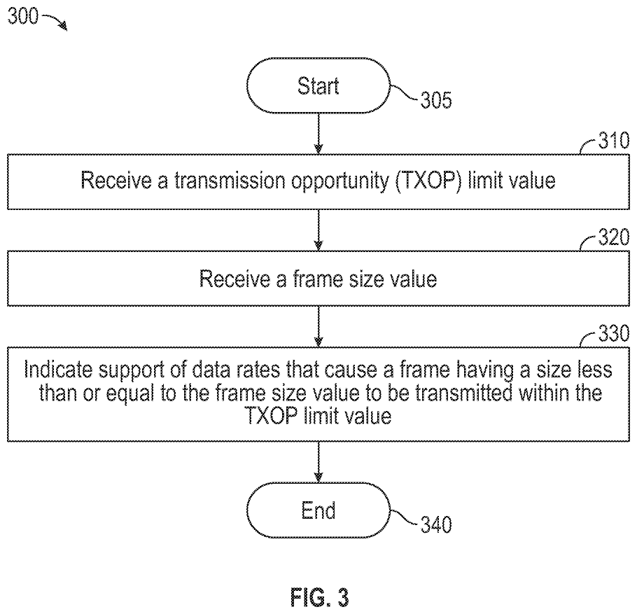

FIG. 3 is a flow chart setting forth the general stages involved in a method 300 consistent with an embodiment of the disclosure for providing preemption in wireless. Method 300 may be implemented using first AP 125 as described in more detail above with respect to FIG. 1. Ways to implement the stages of method 300 will be described in greater detail below.

Method 300 may begin at starting block 305 and proceed to stage 310 where first AP 125 may receive a Transmission Opportunity (TXOP) limit value. For example, to reduce the latency, embodiments of the disclosure may ensure that all transmissions are short. This may be achieved by: i) a controlled environment to avoid primary spectrum users and unmanaged Basic Service Sets (BSSs) (e.g., this may be achieved in the environments such as industrial settings where end-device access to controlled manufacturing areas may be restricted); and ii) a small TXOP limit (e.g., T=600 μs).

From stage 310, where first AP 125 receives the TXOP limit value, method 300 may advance to stage 320 where first AP 125 may receive a frame size value. For example, a frame size value may comprise 1500B (e.g., ignoring preambles, IFS, acknowledgements, etc.).

Once first AP 125 receives the frame size value in stage 320, method 300 may continue to stage 330 where first AP 125 may indicate support of data rates that cause a frame having a size less than or equal to the frame size value to be transmitted within the TXOP limit value. For example, a small TXOP limit may permit a single frame to be sent at whatever data rate (e.g., within the Modulation and Coding Scheme (MCS)). Therefore, first AP 125 may delete all low data rates from the supported rates and BSS membership selectors element and the High Throughput (HT) operation element. The latter may then be recycled for Very High Throughput (VHT). If first AP 125 deletes all rates under 24 Mbps or under 36 Mbps, this may suffice. For example, a 1500B frame at [6 24 36] Mbps takes [2000 500 333.3] is (e.g., ignoring preambles, IFS, acknowledgements, etc.). In other words, sending 1500B at 24 Mbps and 36 Mbps may be done in 500 μs and 333.3 μs respectively and both within the T=600 μs limit. However, 1500B at 6 Mbps may be done in 2000 μs which is outside the T=600 μs limit.

First AP 125 may indicate a lack of support for explicit sounding due to the potentially large feedback that may be often sent at a low MCS without regard to Media Access Control (MAC)-level signaling. However, first AP 125 may only perform explicit sounding with clients that may be known to use a higher MCS for their sounding feedback. Once first AP 125 indicates support of data rates that cause the frame having the size less than or equal to the frame size value to be transmitted within the TXOP limit value in stage 330, method 300 may then end at stage 340.

With other embodiments of the disclosure, first AP 125 may only allow preemption traffic to use the preemption AC (e.g., AC-VO). This may be achieved by the Wi-Fi Alliance (WFA) QoS Management R2 (including R1 features) certification wherein the AP may specify that the mapping from application to a Differentiated Service Code Point (DSCP) to a User Priority (UP)˜Traffic Identifier (TID) should be assigned the smallest backoff value (e.g., 0). Only the application (or applications) that need preemptible service are configured to use an UP˜TID associated with the preemptible AC.

In yet another embodiment, an apparent semi-failure mode may include a frame arriving for transmission at a client device marked for preemption while the medium is idle (e.g., at least Short Interframe Space (SIFS) after the last transmission). Then the client device may contend but, because it may start a little later than SIFS, so it may transmit after the CWₘₐₓ+n slots after the end of SIFS and then its transmission may collide with any other client device. However, fortunately, after the collision, when it recognizes the acknowledgement is not coming, it may contend again. This may be within the first CWₘₐₓ+n slots after the end of SIFS which is a duration protected from all other client device. Thus, this scenario may not affect the efficiency of the process.

Yet another embodiment may comprise an optional enhancement that may fall out of the standard, but only for the devices allowed to perform preemption. If the deployment is controlled such that only a small number of client devices are permitted in the BSS and a smaller number are allowed to preempt, then: i) each such client device may be assigned a distinct backoff value (taken from 0 . . . CWₘₐₓ); and ii) each client device's Network Allocation Vector (NAV) may be restarted after every PPDU. Then all such client devices may have a unique slot after a TXOP and so that it may preempt without collision. The highest priority preempting client device may be assigned the smallest backoff value (e.g., 2 slots after SIFS), and the lowest priority preempting client device may be assigned the largest backoff value (e.g., CWₘₐₓ slots after SIFS).

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing preemption in wireless as described above with respect to FIG. 2 and FIG. 3. Computing device 400, for example, may provide an operating environment for controller 105, first AP 125, second AP 130, first client device 135, second client device 140, or third client device 145. Controller 105, first AP 125, second AP 130, first client device 135, second client device 140, and third client device 145 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure

1. A method comprising:
receiving, by a computing device, preemption Access Category (AC) parameters for a preemption AC within a plurality of ACs, wherein the preemption AC parameters comprise a Contention Window maximum (CWₘₐₓ) comprising a first predetermined value and a preemption Arbitrary Interframe Space Number (AIFSN) of less than or equal to a second predetermined value;
receiving AC parameters for others of the plurality of ACs wherein a non-preemption AIFSN associated with any of the others of the plurality of ACs is greater than a sum of the first predetermined value the second predetermined value; and
allowing preemption for traffic in the preemption AC.

2. The method of claim 1, further advertising the preemption AC parameters and the AC parameters for the others of the plurality of ACs.

3. The method of claim 1, wherein the first predetermined value is equal to 0 and the first predetermined value is equal to 14.

4. The method of claim 1, wherein the first predetermined value is equal to 1 and the second predetermined value is equal to 13.

5. The method of claim 1, wherein the first predetermined value is equal to 3 and the second predetermined value is equal to 11.

6. The method of claim 1, wherein the first predetermined value is equal to 7 and the second predetermined value is equal to 7.

7. The method of claim 1, wherein a Contention Window minimum (CWₘᵢₙ) for the preemption AC parameters is less than or equal to the CWₘₐₓ.

8. The method of claim 1, wherein the preemption AC parameters and the AC parameters for the others of the plurality of ACs comprise Wi-Fi Multimedia (WMM) parameters.

9. The method of claim 1, wherein the preemption AC parameters and the AC parameters for the others of the plurality of ACs comprise Enhanced Distributed Channel Access (EDCA) parameters.

10. The method of claim 1, wherein the traffic comprises Time Sensitive Networking (TSN) traffic.

11. The method of claim 1, wherein the computing device comprises an Access Point (AP).

12. A method comprising:
receiving, by a computing device, a Transmission Opportunity (TXOP) limit value;
receiving a frame size value; and
indicating support of data rates that cause a frame having a size less than or equal to the frame size value to be transmitted within the TXOP limit value.

13. The method of claim 12, wherein indicating support of the data rates comprises advertising Modulation and Coding Scheme (MCS) index values that have an associated data rate that cause the frame having the size less than or equal to the frame size value to be transmitted within the TXOP limit value.

14. The method of claim 12, wherein the TXOP limit value is less than or equal to 600 μs.

15. The method of claim 12, wherein the computing device is an Access Point (AP).

16. The method of claim 12, further comprising indicating a lack of support for explicit sounding.

17. The method of claim 12, wherein the size of the frame excludes at least one of a preamble, an Interframe Spacing (IFS), and an acknowledgement.

18. A system comprising:
a memory storage; and
a processing unit coupled to the memory storage, wherein the processing unit is operative to:
receive preemption Access Category (AC) parameters for a preemption AC within a plurality of ACs, wherein the preemption AC parameters comprise a Contention Window maximum (CWₘₐₓ) comprising a first predetermined value and a preemption Arbitrary Interframe Space Number (AIFSN) of less than or equal to a second predetermined value;
receive AC parameters for others of the plurality of ACs wherein a non-preemption AIFSN associated with any of the others of the plurality of ACs is greater than a sum of the first predetermined value the second predetermined value;
allow preemption for traffic in the preemption AC; and
advertise the preemption AC parameters and the AC parameters for the others of the plurality of ACs.

19. The system of claim 18, wherein the preemption AC parameters and the AC parameters for the others of the plurality of ACs comprise Enhanced Distributed Channel Access (EDCA) parameters.

20. The system of claim 18, wherein the traffic comprises Time Sensitive Networking (TSN) traffic.
